(19) United States
(12) Patent Application Publication
(10) Pub. No.: US 2026/0118951 A1
(43) Pub. Date: Apr. 30, 2026

(54) INFORMATION DISPLAY METHOD AND APPARATUS, ELECTRONIC DEVICE, AND STORAGE MEDIUM

(71) Applicant: Beijing Zitiao Network Technology Co., Ltd., Beijing (CN)

(72) Inventors: Rongxuan MU, Beijing (CN); Chi FANG, Beijing (CN); Shuo LIU, Beijing (CN); Jia GUO, Beijing (CN); Mengqian LIU, Beijing (CN)

(21) Appl. No.: 19/003,673

(22) Filed: Dec. 27, 2024

(30) Foreign Application Priority Data
Dec. 28, 2023 (CN) 202311844084.2

(51) Int. Cl. G06F 3/01; G02B 27/01

(52) U.S. Cl. CPC G06F 3/012; G02B 27/0172; G06F 3/013; G02B 2027/0187

(57) ABSTRACT

The present application discloses an information display method and apparatus, an electronic device, and a storage medium. The method includes: obtaining current head pose information and head movement information of a user; predicting, based on the current head pose information and the head movement information of the user, an eye gaze point position of the user in a virtual reality space; and displaying visual indication information at the eye gaze point position.

### CROSS REFERENCE TO RELATED APPLICATIONS

This present application claims the benefit of priority to Chinese Application No. 202311844084.2, filed on Dec. 28, 2023, the entire contents of which are incorporated herein by reference.

### TECHNICAL FIELD

The present application belongs to the field of computer technologies, and in particular, to an information display method and apparatus, an electronic device, and a storage medium.

### BACKGROUND

An Extended Reality (XR) technology can combine reality with virtual reality through a computer, to provide a user with a virtual reality space that can be used for human-computer interaction. In the virtual reality space, the user can perform social interaction, entertainment, learning, work, and the like by using an extended reality XR device, to implement human-computer interaction. Human-computer interaction may include various interaction manners such as eye tracking and gesture recognition. Eye tracking determines an eye gaze point of a person by tracking an eyeball, to control a cursor in the virtual reality space based on the eye gaze point. Compared with other interaction manners, eye tracking interaction is more smooth and natural.

### SUMMARY

The present application provides an information display method and apparatus, an electronic device, and a storage medium.

According to a first aspect, the present application provides an information display method, the method comprising:
obtaining current head pose information and head movement information of a user;
predicting, based on the current head pose information and the head movement information of the user, an eye gaze point position of the user in a virtual reality space; and
displaying visual indication information at the eye gaze point position.

According to the information display method of the present application, the current head pose information and the head movement information of the user are obtained, so as to predict the eye gaze point position of the user in the extended reality space based on the current head pose information and the head movement information of the user.

According to an embodiment of the present application, the predicting, based on the current head pose information and the head movement information of the user, an eye gaze point position of the user in a virtual reality space comprises:
determining a head gaze point position of the user in the virtual reality space based on the current head pose information of the user; and
predicting the eye gaze point position of the user in the virtual reality space based on the head gaze point position and the head movement information.

According to an embodiment of the present application, the predicting the eye gaze point position of the user in the virtual reality space based on the head gaze point position and the head movement information comprises:
determining gaze point offset information corresponding to the head movement information; and
predicting the eye gaze point position of the user in the virtual reality space based on the head gaze point position and the gaze point offset information.

According to an embodiment of the present application, the predicting, based on the current head pose information and the head movement information of the user, an eye gaze point position of the user in a virtual reality space comprises:
inputting the current head pose information and the head movement information of the user into an eye gaze point prediction model, to obtain the eye gaze point position of the user in the virtual reality space.

According to an embodiment of the present application, the method further comprises:
obtaining gaze point influence information; and
the inputting the current head pose information and the head movement information of the user into an eye gaze point prediction model, to obtain the eye gaze point position of the user in the virtual reality space comprises:
inputting the current head pose information, the head movement information, and the gaze point influence information of the user into the eye gaze point prediction model, to obtain an eye gaze point position of the user in the virtual reality space that corresponds to the gaze point influence information.

According to an embodiment of the present application, the gaze point influence information comprises at least one of environmental information of a real environment in which the user is located, an interaction scenario type, an interaction task type, an interaction application type, a user role type, and user behavior information.

According to an embodiment of the present application, a training method of the eye gaze point prediction model comprises:
obtaining historical eye information and historical head information, the historical eye information comprising historical eye movement information and historical movement information, and the historical head information comprising historical head pose information and historical head movement information; and
training the eye gaze point prediction model based on the historical eye information and the historical head information.

According to an embodiment of the present application, the head movement information comprises at least one of a head movement speed and a head movement acceleration.

According to a second aspect, the present application provides an information display apparatus, the apparatus comprising:
an obtaining module, configured to obtain current head pose information and head movement information of a user;
a prediction module, configured to predict, based on the current head pose information and the head movement information of the user, an eye gaze point position of the user in a virtual reality space; and
a display module, configured to display visual indication information at the eye gaze point position.

According to the information display apparatus of the present application, the current head pose information and the head movement information of the user are obtained, so as to predict the eye gaze point position of the user in the extended reality space based on the current head pose information and the head movement information of the user.

According to a third aspect, the present application provides an electronic device, comprising a memory, a processor, and a computer program stored in the memory and executable on the processor, wherein the processor implements the information display method according to the above first aspect when executing the computer program.

According to a fourth aspect, the present application provides a non-transitory computer-readable storage medium storing a computer program thereon, wherein the information display method according to the above first aspect is implemented when the computer program is executed by a processor.

According to a fifth aspect, the present application provides a computer program product comprising a computer program, wherein the information display method according to the above first aspect is implemented when the computer program is executed by a processor.

In the above one or more technical solutions in the embodiments of the present application, the current head pose information and the head movement information of the user are obtained, so as to predict the eye gaze point position of the user in the extended reality space based on the current head pose information and the head movement information of the user.

The additional aspects and advantages of the present application will be described in part in the following description, and in part will be obvious from the following description, or may be learned by practice of the present application.

### BRIEF DESCRIPTION OF THE DRAWINGS

The above and/or additional aspects and advantages of the present application will become apparent and easily understandable from the description of the embodiments in conjunction with the following drawings, in which:

FIG. 1 is a schematic flowchart of an information display method according to an embodiment of the present application;

FIG. 2 is a graph of a relationship between a head movement speed and an eye movement speed in the information display method according to an embodiment of the present application;

FIG. 3 is a schematic diagram of a relationship between a head gaze point and an eye gaze point in the information display method according to an embodiment of the present application;

FIG. 4 is a schematic diagram of a structure of an information display apparatus according to an embodiment of the present application;

FIG. 5 is a schematic diagram of a structure of an electronic device according to an embodiment of the present application; and

FIG. 6 is a schematic diagram of hardware of an electronic device according to an embodiment of the present application.

### DETAILED DESCRIPTION OF EMBODIMENTS

The following clearly describes the technical solutions in the embodiments of the present application with reference to the accompanying drawings in the embodiments of the present application. Obviously, the described embodiments are some but not all of the embodiments of the present application. All other embodiments obtained by a person of ordinary skill in the art based on the embodiments of the present application shall fall within the protection scope of the present application.

The terms “first” and “second” in the specification, claims, and drawings of the present application are used to distinguish similar objects, but are not used to describe a specific order or sequence. It should be understood that the data terms so used may be interchanged under appropriate circumstances so that the embodiments of the present application can be implemented in orders other than those illustrated or described herein, and objects that are distinguished by “first”, “second” and the like are usually of the same category, and do not limit the number of objects. For example, a first object may be one or more than one. In addition, “and/or” in the specification and claims indicates at least one of the connected objects. The character “/” generally indicates an “or”relationship between the related objects.

It is realized that the hardware performance of some extended reality devices is limited, and the eye tracking accuracy is relatively low, so that the position of the cursor cannot be accurately determined, thereby affecting the accuracy of interaction. In addition, for some extended reality devices, the eye tracking function fails or the eye tracking function is not available, and other interaction manners are used, which affects the smoothness and naturalness of interaction, thereby affecting the user interaction experience.

The present application is intended to solve at least one of the technical problems existing in the related art. To this end, the present application provides an information display method and apparatus, an electronic device, and a storage medium, which can accurately determine a display position of visual indication information, improve accuracy of interaction, and improve smoothness and naturalness of interaction. The following describes in detail the information display method and apparatus, an electronic device, and a storage medium provided in the embodiments of the present application with reference to the accompanying drawings and through specific embodiments and application scenarios thereof.

The information display method may be applied to a terminal, and may be specifically executed by hardware or software in the terminal.

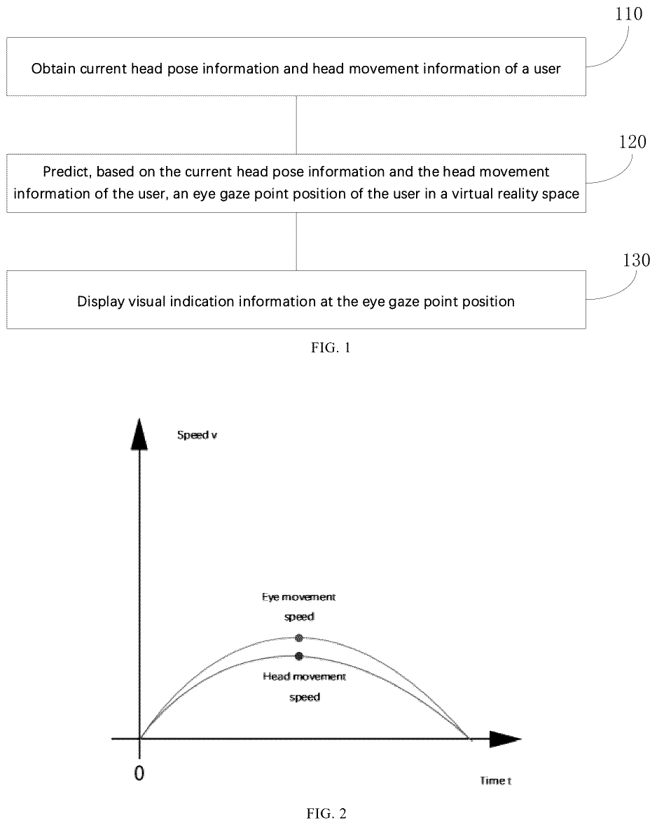

FIG. 1 is a schematic flowchart of an information display method according to an embodiment of the present application.

The information display method provided in this embodiment of the present application may be performed by an electronic device or a functional module or a functional entity in the electronic device that can implement the interaction method. The following describes the interaction method provided in this embodiment of the present application by using the electronic device as an execution subject as an example. The electronic device may be a Virtual Reality (VR) device, an Augmented Reality (AR) device, an Extended Reality (XR) device, a Mixed Reality (MR) device, or the like.

As shown in FIG. 1, the information display method includes step 110, step 120, and step 130.
Step 110: Obtain current head pose information and head movement information of a user.

The electronic device may include a head-mounted device, and the head-mounted device is worn on the head of the user. The head pose information and the head movement information of the user may be collected in real time through the head-mounted device. The head pose information may include head position information and head posture information, and the head posture information may include a pitch angle, a yaw angle, and a roll angle of the head. The head movement information may include at least one of a head movement speed and a head movement acceleration.
Step 120: Predict, based on the current head pose information and the head movement information of the user, an eye gaze point position of the user in a virtual reality space.

The virtual reality space may be a corresponding virtual environment simulated by the electronic device for a real interactive scene selected by the user, to perform corresponding interaction in the virtual reality space. The virtual reality space may be a simulation environment of a real world, a semi-simulated and semi-virtual virtual scene, or a purely-virtual virtual scene.

The user may enter the virtual reality space through the electronic device. An interactive object is provided in the virtual reality space, and the user may interact with the interactive object in the virtual reality space.

When the eye tracking accuracy of the electronic device is low, or the eye tracking function fails, or the electronic device does not have the eye tracking function, in this embodiment, the head pose information and the head movement information of the user may be obtained, to predict the eye gaze point position of the user in the virtual reality space based on the current head pose information and the head movement information of the user.

In some embodiments, the predicting, based on the current head pose information and the head movement information of the user, an eye gaze point position of the user in a virtual reality space in step 120 comprises:
determining a head gaze point position of the user in the virtual reality space based on the current head pose information of the user; and
predicting the eye gaze point position of the user in the virtual reality space based on the head gaze point position and the head movement information.

The head gaze point position refers to a position in the virtual reality space to which a head virtual ray emitted outward from the head points. A direction of the head virtual ray may be determined based on the current head pose information of the user, and then a position in the virtual reality space to which the head virtual ray points is determined, that is, the head gaze point position of the user in the virtual reality space, and the head gaze point position may include spatial position coordinates.

The eye gaze point position refers to a position in the virtual reality space to which an eye virtual ray emitted outward from the eye points. The eye tracking accuracy of the electronic device in this embodiment is low, or the eye tracking function fails, or the electronic device does not have the eye tracking function. Therefore, the electronic device in this embodiment may not determine a position in the virtual space to which the eye virtual ray points by tracking the eyeball, but predict a position in the virtual reality space to which the eye virtual ray points by tracking the head, that is, predict the eye gaze point position.

Because the head movement information is different from the eye movement information within the same time period, the head gaze point position is different from the eye gaze point position. As shown in FIG. 2, during the head movement of the user, the eye (that is, the eyeball) of the user also moves, and the eye movement speed of the user is greater than the head movement speed of the user, and the eye movement acceleration of the user is greater than the head movement acceleration of the user, which further causes the head gaze point of the user and the eye gaze point to be located at different positions, that is, the eye gaze point is offset from the head gaze point to a certain extent.

In some embodiments, the step of predicting the eye gaze point position of the user in the virtual reality space based on the head gaze point position and the head movement information comprises:
determining gaze point offset information corresponding to the head movement information; and
predicting the eye gaze point position of the user in the virtual reality space based on the head gaze point position and the gaze point offset information.

The gaze point offset information refers to offset information of the eye gaze point position relative to the head gaze point position. Different head movement information corresponds to different gaze point offset information.

There may be various methods for determining the gaze point offset information corresponding to the head movement information.

In a first implementation, a correspondence between the head movement information and the gaze point offset information is preset. For example, the head movement information comprises a head movement speed and a head movement acceleration. A greater head movement speed corresponds to greater gaze point offset information; and a greater head movement acceleration corresponds to greater gaze point offset information.

After the current head movement information of the user is obtained, the gaze point offset information corresponding to the current head movement information of the user may be determined based on the preset correspondence between the head movement information and the gaze point offset information.

The correspondence between the head movement information and the gaze point offset information may be set based on historical head information and historical eye information. The historical head information and the historical eye information may be information historically collected by the electronic device in this embodiment (when the eye tracking function does not fail) or another electronic device (such as an electronic device with an eye tracking function and high eye tracking accuracy).

The historical head information may include historical head pose information and historical head movement information, the historical head pose information may determine a historical head gaze point position, and the historical head movement information comprises at least one of a historical head movement speed and a historical head movement acceleration. The historical eye information may include historical eye movement information and historical movement information, the historical eye movement information is information collected by tracking the eyeball, the historical eye movement information may determine a historical eye gaze point position, and the historical movement information comprises at least one of a historical eye movement speed and a historical eye movement acceleration.

The correspondence between the head movement information and the gaze point offset information may be set based on the historical head information and the historical eye information within the same historical time period. The gaze point offset information corresponding to the current head movement information of the user is determined based on the correspondence between the head movement information and the gaze point offset information. The current eye gaze point position of the user may be predicted based on the current head gaze point position of the user and the corresponding gaze point offset information.

In a second implementation, because the eye movement speed/acceleration is greater than the head movement speed/acceleration, an interval duration may be set, and it is assumed that the head movement acceleration is fixed within the interval duration. The gaze point offset information corresponding to the current head movement information of the user is calculated according to the interval duration, the head movement speed, and the head movement acceleration by using a prediction algorithm.

The interval duration may be adjusted and optimized based on head movement characteristics and eye movement characteristics. For example, the interval duration is adjusted and optimized based on the historical head information and the historical eye information. The historical head information and the historical eye information may be information historically collected by the electronic device in this embodiment (when the eye tracking function does not fail) or another electronic device (such as an electronic device with an eye tracking function and high eye tracking accuracy).

After the gaze point offset information corresponding to the current head movement information of the user is calculated according to the interval duration, the head movement speed, and the head movement acceleration, the current eye gaze point position of the user may be predicted based on the current head gaze point position of the user and the corresponding gaze point offset information.

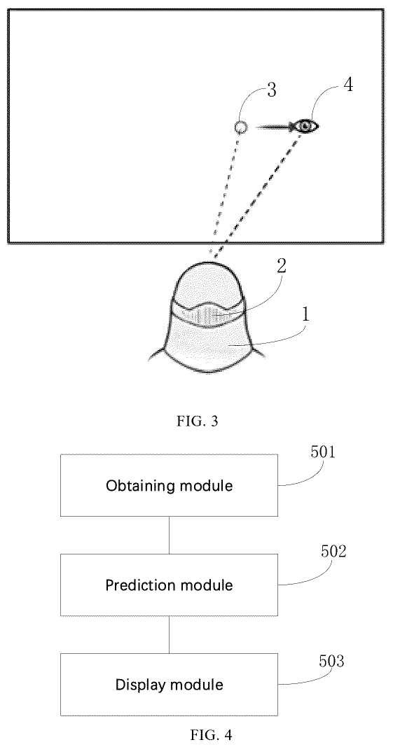

As shown in FIG. 3, a head of a user 1 wears a head-mounted device 2. The current head pose information and the head movement information of the user are obtained through the head-mounted device 2, and a position in the virtual reality space to which a head virtual ray points, that is, the head gaze point position (a position of a head gaze point 3) is determined based on the current head pose information of the user. Corresponding gaze point offset information is determined based on the current head movement information of the user. The head gaze point position is offset according to the corresponding gaze point offset information, to simulate a position in the virtual reality space to which an eye virtual ray points, that is, the current eye gaze point position of the user (a position of an eye gaze point 4) is predicted.

In some embodiments, the predicting, based on the current head pose information and the head movement information of the user, an eye gaze point position of the user in a virtual reality space in step 120 comprises:
inputting the current head pose information and the head movement information of the user into an eye gaze point prediction model, to obtain the eye gaze point position of the user in the virtual reality space.

In this embodiment, the eye gaze point prediction model is constructed and trained, so that the current head pose information and the head movement information of the user are input into the trained eye gaze point model, and the eye gaze point model analyzes a correspondence between the head gaze point position and the eye gaze point position, to predict the eye gaze point position of the user. The eye gaze point prediction model may be a neural network model, such as a convolutional neural network or a recurrent neural network, or may be another model, which is not specifically limited herein.

A training method of the eye gaze point prediction model comprises:
obtaining historical eye information and historical head information, the historical eye information comprising historical eye movement information and historical movement information, and the historical head information comprising historical head pose information and historical head movement information; and
training the eye gaze point prediction model based on the historical eye information and the historical head information.

The historical head information and the historical eye information may be information historically collected by the electronic device in this embodiment (when the eye tracking function does not fail) or another electronic device (such as an electronic device with an eye tracking function and high eye tracking accuracy).

The historical head information may include historical head pose information and historical head movement information, the historical head pose information may determine a historical head gaze point position, and the historical head movement information comprises at least one of a historical head movement speed and a historical head movement acceleration. The historical eye information may include historical eye movement information and historical movement information, the historical eye movement information is information collected by tracking the eyeball, the historical eye movement information may determine a historical eye gaze point position, and the historical movement information comprises at least one of a historical eye movement speed and a historical eye movement acceleration.

The historical head information and the historical eye information within the same historical time period are input into the eye gaze point prediction model, to train the eye gaze point prediction model. After the eye gaze point prediction model is trained, the current head pose information and the head movement information of the user are input into the eye gaze point prediction model, to predict the current eye gaze point position of the user.

In some embodiments, the information display method further comprises:
obtaining gaze point influence information.

It should be noted that for different scenarios and different users, interaction behaviors may also be different. For different interaction behaviors, the eye gaze point position of the user may be adjusted to better conform to the behavior intention of the user.

The gaze point influence information refers to information that may affect the eye gaze point position of the user. In some embodiments, the gaze point influence information may include at least one of environmental information of a real environment in which the user is located, an interaction scenario type, an interaction task type, an interaction application type, a user role type, and user behavior information.

The environmental information of the real environment in which the user is located may include brightness of the real environment in which the user is located. Changes in environmental information may affect information collection of the electronic device, thereby affecting the eye gaze point position.

The interaction scenario type refers to a type of a virtual environment corresponding to the virtual reality space, such as a game scenario, a work scenario, and an educational scenario. In different types of interaction scenario s, interaction requirements may be different, and requirements for the eye gaze point position may also be different. For example, in a game scenario, there is a higher requirement for the accuracy of the eye gaze point position, and a faster response speed.

The interaction task type refers to a type of a task performed by the user, such as search, click, and input. When the user performs different types of interaction tasks, interaction requirements may be different, and requirements for the eye gaze point position may also be different.

The interaction application type refers to a type of an application with which the user interacts, such as a browser, office software, and a game. When the user uses different types of applications, interaction requirements may be different, and requirements for the eye gaze point position may also be different.

The user role type refers to a role type of the user during interaction, such as a player, a worker, and a student. When the user is in different types of roles, interaction requirements may be different, and requirements for the eye gaze point position may also be different.

The user behavior information refers to behavior information exhibited by the user during interaction, such as a user operation habit, a location of the user, an emotion state of the user, and a cognitive level of the user. The user operation habit may include a dominant hand of the user and a dominant operation manner of the user. The location of the user may include an office, a home, and a public place. The emotion state of the user may include excitement, fatigue, and anxiety. The cognitive level of the user may include a primary level, an intermediate level, and an advanced level. When the user exhibits different behaviors, interaction requirements may be different, and requirements for the eye gaze point position may also be different.

When the gaze point influence information is obtained, the step of inputting the current head pose information and the head movement information of the user into an eye gaze point prediction model, to obtain the eye gaze point position of the user in the virtual reality space comprises:
inputting the current head pose information, the head movement information, and the gaze point influence information of the user into the eye gaze point prediction model, to obtain an eye gaze point position of the user in the virtual reality space that corresponds to the gaze point influence information.

The current head pose information, the head movement information, and the gaze point influence information of the user are input into the eye gaze point prediction model, so that the eye gaze point prediction model may analyze a correspondence between the head gaze point position and the eye gaze point position for different gaze point influence information, to predict the eye gaze point position corresponding to the gaze point influence information.

Use of the gaze point influence information may provide context information for the eye gaze point prediction model, to help the eye gaze point model understand a behavior background of the user. For example, the gaze point influence information includes an interaction scenario type. When the interaction scenario type is a game scenario, the eye gaze point model analyzes that a next operation of the user is related to a game based on the game scenario, and then predicts the eye gaze point position of the user based on a game-related operation and the head gaze point position.

Use of the gaze point influence information may improve prediction accuracy of the eye gaze point position. For example, the gaze point influence information includes an interaction task type. When the interaction task type is search, the eye gaze point model analyzes that a next operation of the user is to click a search result based on a search task, and then predicts the eye gaze point position of the user based on an operation of clicking the search result and the head gaze point position.

Use of the gaze point influence information may widen an application range. For example, the gaze point influence information includes user behavior information. The eye gaze point model analyzes a user interaction behavior based on the user behavior information, and then predicts the eye gaze point position of the user based on the user interaction behavior and the head gaze point position.

In this embodiment, it is possible to help the eye gaze point model better understand the behavior intention of the user in conjunction with the gaze point influence information, thereby improving the prediction accuracy, widening the application range, and implementing higher-level and more complex interaction prediction, which is suitable for highly personalized and context-sensitive interaction design.

When the gaze point influence information is obtained, a training method of the eye gaze point prediction model comprises:
obtaining historical eye information, historical head information, and interaction point influence information, the historical eye information comprising historical eye movement information and historical movement information, and the historical head information comprising historical head pose information and historical head movement information; and training the eye gaze point prediction model based on the historical eye information, the historical head information, and the interaction point influence information.

The interaction point influence information and the historical head information and the historical eye information within the same historical time period are input into the eye gaze point prediction model, to train the eye gaze point prediction model. After the eye gaze point prediction model is trained, the interaction point influence information and the current head pose information and the head movement information of the user are input into the eye gaze point prediction model, to predict the current eye gaze point position of the user.
Step 130: Display visual indication information at the eye gaze point position.

After the eye gaze point position is predicted, the gaze point position may be used as a position of the visual indication information, and the visual indication information is moved to this position. The visual indication information indicates a current interaction position. The visual indication information may be displayed in the form of a cursor, a gesture icon, or the like.

In this embodiment, the eye gaze point position is accurately predicted based on the head pose information and the head movement information, so that the position of the visual indication information is accurately determined, and the movement of the visual indication information is accurately controlled, thereby improving the accuracy of interaction. In addition, the eye tracking is simulated by predicting the eye gaze point position, thereby improving the smoothness and naturalness of interaction, especially in fast or continuous movement, and being suitable for a dynamic and complex interactive environment.

After the position of the visual indication information is determined, the visual indication information is moved to this position, to determine the interactive object pointed to by the visual indication information. After the interactive object corresponding to the visual indication information is determined, the interactive object may be displayed with a visual effect such as highlighting and/or zooming in, to remind the user of the currently selected interactive object.

If the visual indication information does not point to any interactive object, it may be detected whether the visual indication information is located in an interaction range of an interactive object, and the interaction range may be preset. If the visual indication information is located in an interaction range of an interactive object, the interactive object is used as a potential interactive object that may be selected by the user, and the potential interactive object may be displayed with a visual effect such as highlighting and/or zooming in, to remind the user of the currently selected interactive object.

After the interactive object is selected, a related event of the interactive object may be triggered. The related event may be any event. For example, the related event may include at least one of displaying prompt information, displaying a special effect, and performing an operation. The related event may further include another event, which is not specifically limited herein.

The displayed prompt information may be an introduction to or an operation instruction for the interactive object. Displaying the prompt information may help the user to understand or operate the object to be interacted with. The prompt information may include at least one of text information, voice information, two-dimensional image information, and three-dimensional image information. In other words, the prompt information may be displayed in a manner of text, voice, a two-dimensional picture, or three-dimensional dynamic demonstration, which is not specifically limited herein.

The displayed special effect may include at least one of a sound special effect and a visual special effect. For example, the interactive object is an object to be shot, and after the object to be shot is selected, a special effect of shooting the object to be shot may be triggered.

The performed operation may be any operation associated with the interactive object. For example, the interactive object is a button, and after the button is selected, an operation of pressing the button may be triggered.

In this embodiment, after the position of the visual indication information is accurately determined, the interactive object pointed to by the visual indication information is determined, and the related event corresponding to the interactive object is triggered, to implement rich interaction between the user and the interactive object, thereby improving the user interaction experience.

According to the information display method provided in this embodiment of the present application, the current head pose information and the head movement information of the user are obtained, so as to predict the eye gaze point position of the user in the extended reality space based on the current head pose information and the head movement information of the user, that is, the eye gaze point position is accurately predicted without the need to obtain eye movement information, and the visual indication information is displayed at the eye gaze point position, that is, the display position of the visual indication information is accurately determined, thereby improving the accuracy of interaction, and the eye tracking is simulated by predicting the eye gaze point position, thereby improving the smoothness and naturalness of interaction, thereby improving the user interaction experience.

An execution subject of the information display method provided in this embodiment of the present application may be an information display apparatus. In this embodiment of the present application, the information display apparatus provided in this embodiment of the present application is described, with the information display method being performed by the information display apparatus as an example.

This embodiment of the present application further provides an information display apparatus.

As shown in FIG. 4, the information display apparatus includes: an obtaining module 501, a prediction module 502, and a determining module 503.

The obtaining module 501 is configured to obtain current head pose information and head movement information of a user;
the prediction module 502 is configured to predict, based on the current head pose information and the head movement information of the user, an eye gaze point position of the user in a virtual reality space; and
the display module 503 is configured to display visual indication information at the eye gaze point position.

According to the information display apparatus of the present application, the current head pose information and the head movement information of the user are obtained, so as to predict the eye gaze point position of the user in the extended reality space based on the current head pose information and the head movement information of the user, that is, the eye gaze point position is accurately predicted without the need to obtain eye movement information, and the visual indication information is displayed at the eye gaze point position, that is, the display position of the visual indication information is accurately determined, thereby improving the accuracy of interaction, and the eye tracking is simulated by predicting the eye gaze point position, thereby improving the smoothness and naturalness of interaction, thereby improving the user interaction experience.

In some embodiments, the prediction module 502 is further configured to:
determine a head gaze point position of the user in the virtual reality space based on the current head pose information of the user; and
predict the eye gaze point position of the user in the virtual reality space based on the head gaze point position and the head movement information.

In some embodiments, the prediction module 502 is further configured to:
determine gaze point offset information corresponding to the head movement information; and
predict the eye gaze point position of the user in the virtual reality space based on the head gaze point position and the gaze point offset information.

In some embodiments, the prediction module 502 is further configured to:
input the current head pose information and the head movement information of the user into an eye gaze point prediction model, to obtain the eye gaze point position of the user in the virtual reality space.

In some embodiments, the apparatus further comprises an information obtaining module, and the information obtaining module is configured to:
obtain gaze point influence information; and
the prediction module 502 is further configured to:
input the current head pose information, the head movement information, and the gaze point influence information of the user into the eye gaze point prediction model, to obtain an eye gaze point position of the user in the virtual reality space that corresponds to the gaze point influence information.

In some embodiments, the gaze point influence information comprises at least one of environmental information of a real environment in which the user is located, an interaction scenario type, an interaction task type, an interaction application type, a user role type, and user behavior information.

In some embodiments, the apparatus further comprises a training module, and the training module is configured to:
obtain historical eye information and historical head information, the historical eye information comprising historical eye movement information and historical movement information, and the historical head information comprising historical head pose information and historical head movement information; and
train the eye gaze point prediction model based on the historical eye information and the historical head information.

In some embodiments, the head movement information comprises at least one of a head movement speed and a head movement acceleration.

The information display apparatus in the embodiments of the present application may be an electronic device, or may be a component in the electronic device, for example, an integrated circuit or a chip. The electronic device may be a terminal, or may be another device except the terminal. For example, the electronic device may be a Virtual Reality (VR) device, an Augmented Reality (AR) device, an Extended Reality (XR) device, a Mixed Reality (MR) device, or the like, which is not specifically limited in the embodiments of the present application.

The information display apparatus in the embodiments of the present application may be a device with an operating system. The operating system may be a Windows operating system, an Android operating system, an IOS operating system, or another possible operating system, which is not specifically limited in the embodiments of the present application.

The information display apparatus provided in the embodiments of the present application can implement each process of the method embodiments. To avoid repetition, details are not described herein again.

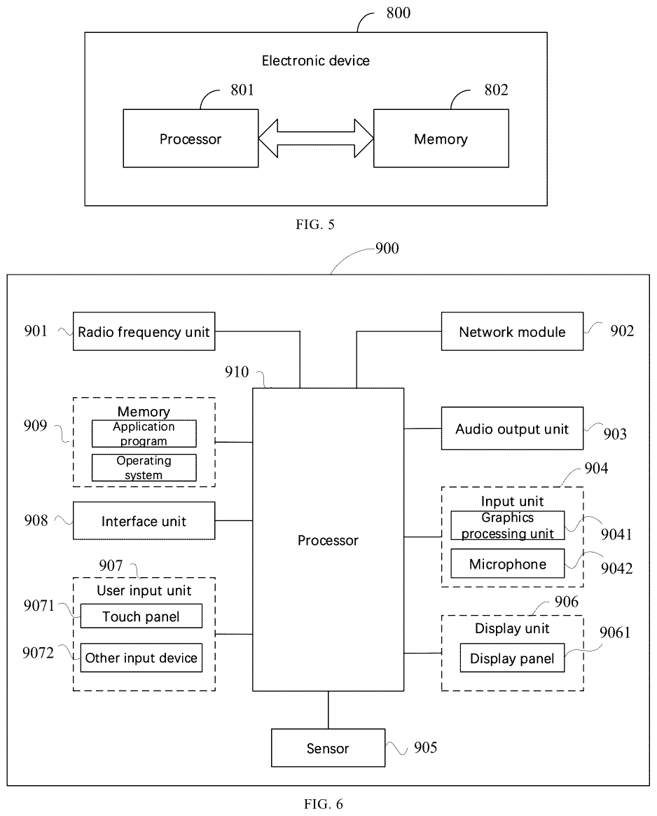

In some embodiments, as shown in FIG. 5, an embodiment of the present application further provides an electronic device 800. The electronic device 800 includes a processor 801, a memory 802, and a computer program stored in the memory 802 and executable on the processor 801. When the program is executed by the processor 801, each process of the above information display method embodiment is implemented, and the same technical effect can be achieved. To avoid repetition, details are not described herein again.

FIG. 6 is a schematic diagram of a hardware structure of an electronic device according to an embodiment of the present application.

The electronic device 900 includes but is not limited to components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the electronic device 900 may further include a power supply (such as a battery) that supplies power to each component, and the power supply may be logically connected to the processor 910 through a power management system, so that functions such as charging, discharging, and power consumption management are implemented through the power management system. The structure of the electronic device shown in FIG. 6 does not constitute a limitation on the electronic device, and the electronic device may include more or fewer components than those shown in the figure, or combine some components, or have a different component arrangement. This is not described again here.

The processor 910 is configured to obtain current head pose information and head movement information of a user; predict, based on the current head pose information and the head movement information of the user, an eye gaze point position of the user in a virtual reality space; and display visual indication information at the eye gaze point position through the display unit 906.

According to the electronic device provided in this embodiment of the present application, the current head pose information and the head movement information of the user are obtained, so as to predict the eye gaze point position of the user in the extended reality space based on the current head pose information and the head movement information of the user, that is, the eye gaze point position is accurately predicted without the need to obtain eye movement information, and the visual indication information is displayed at the eye gaze point position, that is, the display position of the visual indication information is accurately determined, thereby improving the accuracy of interaction, and the eye tracking is simulated by predicting the eye gaze point position, thereby improving the smoothness and naturalness of interaction, thereby improving the user interaction experience.

In some embodiments, the processor 910 is further configured to:
determine a head gaze point position of the user in the virtual reality space based on the current head pose information of the user; and
predict the eye gaze point position of the user in the virtual reality space based on the head gaze point position and the head movement information.

In some embodiments, the processor 910 is further configured to:
determine gaze point offset information corresponding to the head movement information; and
predict the eye gaze point position of the user in the virtual reality space based on the head gaze point position and the gaze point offset information.

In some embodiments, the processor 910 is further configured to:
input the current head pose information and the head movement information of the user into an eye gaze point prediction model, to obtain the eye gaze point position of the user in the virtual reality space.

In some embodiments, the processor 910 is further configured to:
obtain gaze point influence information; and
input the current head pose information, the head movement information, and the gaze point influence information of the user into the eye gaze point prediction model, to obtain an eye gaze point position of the user in the virtual reality space that corresponds to the gaze point influence information.

In some embodiments, the gaze point influence information comprises at least one of environmental information of a real environment in which the user is located, an interaction scenario type, an interaction task type, an interaction application type, a user role type, and user behavior information.

In some embodiments, the processor 910 is further configured to:
obtain historical eye information and historical head information, the historical eye information comprising historical eye movement information and historical movement information, and the historical head information comprising historical head pose information and historical head movement information; and
train the eye gaze point prediction model based on the historical eye information and the historical head information.

In some embodiments, the head movement information comprises at least one of a head movement speed and a head movement acceleration.

It should be understood that in the embodiments of the present application, the input unit 904 may include a graphics processing unit (GPU) 9041 and a microphone 9042, and the GPU 9041 processes image data of a still picture or a video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touch screen. The touch panel 9071 may include two parts: a touch detection apparatus and a touch controller. The other input device 9072 may include but is not limited to a physical keyboard, a function key (such as a volume control key or a switch key), a trackball, a mouse, and a joystick, which are not described herein again.

The memory 909 may be configured to store a software program and various data. The memory 909 may mainly include a first storage area for storing a program or an instruction and a second storage area for storing data, where the first storage area may store an operating system, an application program or an instruction (such as a sound playback function or an image playback function) required by at least one function, and the like. In addition, the memory 909 may include a volatile memory or a non-volatile memory, or the memory 909 may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), or a direct rambus random access memory (DRRAM). The memory 909 in the embodiments of the present application includes but is not limited to these and any other suitable types of memories.

The processor 910 may include one or more processing units. The processor 910 integrates an application processor and a modem processor, where the application processor mainly processes an operation related to an operating system, a user interface, an application program, and the like, and the modem processor mainly processes a wireless communication signal, such as a baseband processor. It may be understood that the foregoing modem processor may not be integrated into the processor 910.

An embodiment of the present application further provides a non-transitory computer-readable storage medium, where a computer program is stored on the non-transitory computer-readable storage medium, and when the computer program is executed by a processor, each process of the above information display method embodiment is implemented, and the same technical effect can be achieved. To avoid repetition, details are not described herein again.

The processor is the processor in the electronic device in the foregoing embodiment. The readable storage medium includes a computer-readable storage medium, such as a read-only memory (ROM), a random access memory (RAM), a magnetic disk, or an optical disc.

An embodiment of the present application further provides a computer program product, including a computer program, where when the computer program is executed by a processor, the above information display method is implemented.

The processor is the processor in the electronic device in the foregoing embodiment. The readable storage medium includes a computer-readable storage medium, such as a ROM, a RAM, a magnetic disk, or an optical disc.

An embodiment of the present application further provides a computer program product, including a computer program, where when the computer program is executed by a processor, the above information display method is implemented.

The processor is the processor in the electronic device in the foregoing embodiment. The readable storage medium includes a computer-readable storage medium, such as a ROM, a RAM, a magnetic disk, or an optical disc.

An embodiment of the present application further provides a chip. The chip includes a processor and a communication interface. The communication interface is coupled to the processor. The processor is configured to run a program or an instruction, to implement each process of the above information display method embodiment, and can achieve the same technical effect. To avoid repetition, details are not described herein again.

It should be understood that the chip mentioned in the embodiments of the present application may also be referred to as a system-level chip, a system chip, a chip system, or a system-on-chip, or the like.

It should be noted that in this specification, the term “include/comprise” or any other variant thereof is intended to cover non-exclusive inclusion, so that a process, a method, an article, or an apparatus that includes a list of elements not only includes those elements but also includes other elements not explicitly listed, or further includes elements inherent to such process, method, article, or apparatus. Without more constraints, an element defined by the statement “include/comprise one . . .” does not exclude the existence of another same element in the process, method, article, or apparatus that includes the element. In addition, it should be noted that in the embodiments of the present application, the scope of the method and the apparatus is not limited to performing a function in an order shown or discussed, and may further include performing the function in a substantially simultaneous manner or in an opposite order according to a function involved. For example, the method described in a different order from that described herein, and various steps may be added, omitted, or combined. In addition, features described with reference to some examples may be combined in other examples.

Through the descriptions of the above embodiments, a person skilled in the art may clearly understand that the above method embodiments may be implemented by software plus a necessary general hardware platform, or may be implemented by hardware. However, in most cases, the former is a better implementation. Based on such an understanding, the technical solutions of the present application essentially, or the part contributing to the prior art, may be implemented in the form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the method described in each embodiment of the present application.

The above embodiments are described with reference to the accompanying drawings, but the present application is not limited to the above specific embodiments, which are merely illustrative rather than restrictive. A person of ordinary skill in the art may make many forms without departing from the spirit and scope of the present application and the scope of the claims, and all of them fall within the protection of the present application.

In the description of this specification, descriptions with reference to the terms “one embodiment”, “some embodiments”, “an illustrative embodiment”, “an example”, “a specific example”, or “some examples” mean that a specific feature, structure, material, or characteristic described in connection with the embodiment or example is included in at least one embodiment or example of the present application. In this specification, the schematic representations of the above terms do not necessarily refer to the same embodiment or example. Moreover, the described specific features, structures, materials, or characteristics may be combined in any one or more embodiments or examples in a suitable manner.

Although the embodiments of the present application have been shown and described, those of ordinary skill in the art may understand that various changes, modifications, substitutions, and variations can be made to these embodiments without departing from the principle and spirit of the present application. The scope of the present application is defined by the claims and their equivalents.

1. An information display method, comprising:
obtaining current head pose information, head movement information, and gaze point influence information of a user;
predicting, based on the current head pose information, the head movement information, and the gaze point influence information of the user, an eye gaze point position of the user in a virtual reality space; and
displaying visual indication information at the eye gaze point position,
wherein the gaze point influence information comprises at least one of environmental information of a real environment in which the user is located, an interaction scenario type, an interaction task type, an interaction application type, or a user role type.

2. The information display method according to claim 1, wherein the predicting, based on the current head pose information and the head movement information of the user, an eye gaze point position of the user in a virtual reality space comprises:
determining a head gaze point position of the user in the virtual reality space based on the current head pose information of the user; and
predicting the eye gaze point position of the user in the virtual reality space based on the head gaze point position and the head movement information.

3. The information display method according to claim 2, wherein the predicting the eye gaze point position of the user in the virtual reality space based on the head gaze point position and the head movement information comprises:
determining gaze point offset information corresponding to the head movement information; and
predicting the eye gaze point position of the user in the virtual reality space based on the head gaze point position and the gaze point offset information.

4. The information display method according to claim 1, wherein the predicting, based on the current head pose information and the head movement information of the user, an eye gaze point position of the user in a virtual reality space comprises:
inputting the current head pose information and the head movement information of the user into an eye gaze point prediction model, to obtain the eye gaze point position of the user in the virtual reality space.

5. The information display method according to claim 4,
wherein the inputting the current head pose information and the head movement information of the user into an eye gaze point prediction model, to obtain the eye gaze point position of the user in the virtual reality space comprises:
inputting the current head pose information, the head movement information, and the gaze point influence information of the user into the eye gaze point prediction model, to obtain an eye gaze point position of the user in the virtual reality space that corresponds to the gaze point influence information.

6. The information display method according to claim 5, wherein the gaze point influence information further comprises user behavior information.

7. The information display method according to claim 4, wherein a training method of the eye gaze point prediction model comprises:
obtaining historical eye information and historical head information, the historical eye information comprising historical eye movement information and historical movement information, and the historical head information comprising historical head pose information and historical head movement information; and
training the eye gaze point prediction model based on the historical eye information and the historical head information. Page 4

8. The information display method according to claim 1, wherein the head movement information comprises at least one of a head movement speed or a head movement acceleration.

9. An electronic device, comprising a memory, a processor, and a computer program stored in the memory and executable on the processor, the processor implements an information display method, comprising:
obtaining current head pose information, head movement information, and gaze point influence information of a user;
predicting, based on the current head pose information, the head movement information, and the gaze point influence information of the user, an eye gaze point position of the user in a virtual reality space; and
displaying visual indication information at the eye gaze point position,
wherein the gaze point influence information comprises at least one of environmental information of a real environment in which the user is located, an interaction scenario type, an interaction task type, an interaction application type, or a user role type.

10. The electronic device according to claim 9, wherein the predicting, based on the current head pose information and the head movement information of the user, an eye gaze point position of the user in a virtual reality space comprises:
determining a head gaze point position of the user in the virtual reality space based on the current head pose information of the user; and
predicting the eye gaze point position of the user in the virtual reality space based on the head gaze point position and the head movement information.

11. The electronic device according to claim 10, wherein the predicting the eye gaze point position of the user in the virtual reality space based on the head gaze point position and the head movement information comprises:
determining gaze point offset information corresponding to the head movement information; and
predicting the eye gaze point position of the user in the virtual reality space based on the head gaze point position and the gaze point offset information.

12. The electronic device according to claim 9, wherein the predicting, based on the current head pose information and the head movement information of the user, an eye gaze point position of the user in a virtual reality space comprises:
inputting the current head pose information and the head movement information of the user into an eye gaze point prediction model, to obtain the eye gaze point position of the user in the virtual reality space.

13. The electronic device according to claim 12, wherein
the inputting the current head pose information and the head movement information of the user into an eye gaze point prediction model, to obtain the eye gaze point position of the user in the virtual reality space comprises:
inputting the current head pose information, the head movement information, and the gaze point influence information of the user into the eye gaze point prediction model, to obtain an eye gaze point position of the user in the virtual reality space that corresponds to the gaze point influence information.

14. The electronic device according to claim 13, wherein the gaze point influence information further comprises user behavior information.

15. A non-transitory computer-readable storage medium storing a computer program thereon, wherein the computer program, when executed by a processor, causes the processor to implement an information display method, comprising:
obtaining current head pose information, head movement information, and gaze point influence information of a user;
predicting, based on the current head pose information, the head movement information, and the gaze point influence information of the user, an eye gaze point position of the user in a virtual reality space; and
displaying visual indication information at the eye gaze point position,
wherein the gaze point influence information comprises at least one of environmental information of a real environment in which the user is located, an interaction scenario type, an interaction task type, an interaction application type, or a user role type.

16. The non-transitory computer-readable storage medium according to claim 15, wherein the predicting, based on the current head pose information and the head movement information of the user, an eye gaze point position of the user in a virtual reality space comprises:
determining a head gaze point position of the user in the virtual reality space based on the current head pose information of the user; and
predicting the eye gaze point position of the user in the virtual reality space based on the head gaze point position and the head movement information.

17. The non-transitory computer-readable storage medium according to claim 16, wherein the predicting the eye gaze point position of the user in the virtual reality space based on the head gaze point position and the head movement information comprises:
determining gaze point offset information corresponding to the head movement information; and
predicting the eye gaze point position of the user in the virtual reality space based on the head gaze point position and the gaze point offset information.

18. The non-transitory computer-readable storage medium according to claim 15, wherein the predicting, based on the current head pose information and the head movement information of the user, an eye gaze point position of the user in a virtual reality space comprises:
inputting the current head pose information and the head movement information of the user into an eye gaze point prediction model, to obtain the eye gaze point position of the user in the virtual reality space.

19. The non-transitory computer-readable storage medium according to claim 18, wherein
the inputting the current head pose information and the head movement information of the user into an eye gaze point prediction model, to obtain the eye gaze point position of the user in the virtual reality space comprises:
inputting the current head pose information, the head movement information, and the gaze point influence information of the user into the eye gaze point prediction model, to obtain an eye gaze point position of the user in the virtual reality space that corresponds to the gaze point influence information.

20. The non-transitory computer-readable storage medium according to claim 19, wherein the gaze point influence information further comprises at user behavior information.
